(19) United States
(12) Patent Application Publication
(10) Pub. No.: US 2018/0284914 A1
(43) Pub. Date: Oct. 4, 2018

(54) PHYSICAL-SURFACE TOUCH CONTROL IN VIRTUAL ENVIRONMENT

(71) Applicant: Intel Corporation, Santa Clara, CA (US)

(72) Inventors: Yaron Yanai, Modiin (IL); Eliyahu Elhadad, Kidron (IL); Kfir Viente, Ramat-GJan (IL); Amir Rosenberger, Ness Ziona (IL); Maoz Madmony, Beit kama (IL)

(21) Appl. No.: 15/474,216

(22) Filed: Mar. 30, 2017

(51) Int. Cl. G06F 3/041; G06F 3/01; G06T 19/00; G06F 3/0488

(52) U.S. Cl. CPC G06F 3/041; G06F 3/012; G06F 3/017; G06F 2203/04808; G06T 19/006; G06F 3/04883; G06F 3/011

(57) ABSTRACT

A head-mounted display (HMD) device to be worn by a user in a physical environment (PE) is controlled. A 3D virtual environment (VE) is modeled to include a virtual controllable object subject to virtual control input. Motion of the position, head, and hands of the user is monitored in the PE, and a physical surface in the PE is detected. A virtual user interface (vUI) is placed in the VE relative to a virtual perspective of the user. The vUI includes an information display and at least one virtual touch control to produce the virtual control input in response to virtual manipulation of the virtual touch control. The vUI's placement is determined to coincide with the physical surface in the PE relative to the position of the user in the PE.

### TECHNICAL FIELD

Embodiments described herein generally relate to information processing and user interfaces and, more particularly, to virtual-reality (VR) and augmented-reality (AR) systems and methods.

### BACKGROUND

Virtual reality (VR) and augmented reality (AR) systems provide an immersive experience for a user by simulating the user's presence in a computer-modeled environment, and facilitating user interaction with that environment. In typical VR/AR implementations, the user wears a head-mounted display (HMD) that provides a stereoscopic display of the virtual environment. Some systems include sensors that track the user's head movement and hands, allowing the viewing direction to be varied in a natural way when the user turns their head about, and for the hands to provide input and, in some cases, be represented in the VR/AR space.

One of the challenges faced by HMD and VR/AR designers is providing a user interface that facilitates user interaction with the application that is displayed in the HMD. Conventional controllers such as a keyboard, mouse or even a touch screen are typically hidden from the user in VR applications, and their normal use contemplates a surface such as a desktop, which limits control to a certain physical area, and might be spatially disconnected from the interaction with the virtual environment. In AR scenarios, the controller might be visible but tends to be limited to its physical location, or, in the case of a remote control or a touch enabled device that occupies the user's hands.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1A is a high-level system diagram illustrating some examples of hardware components of a VR system that may be employed according to some aspects of the embodiments.

FIG. 1B is a diagram illustrating sensors of the HMD of FIG. 1A in greater detail according to an example embodiment.

FIG. 2 is a block diagram illustrating a computing platform in the example form of a general-purpose machine.

FIG. 3 is a diagram illustrating an exemplary hardware and software architecture of a computing device such as the one depicted in FIG. 2, in which various interfaces between hardware components and software components are shown.

FIG. 4 is a block diagram illustrating examples of processing devices that may be implemented on a computing platform, such as the computing platform described with reference to FIGS. 2-3, according to an embodiment.

FIG. 5 is a diagram illustrating an example operational scenario involving an HMD device according to some embodiments.

FIG. 6A is a block diagram illustrating various engines implemented on a computing platform according to various embodiments, to make a special-purpose machine for executing a virtual environment (VE) that interacts with a user who is located in a physical environment (PE).

FIG. 6B is a diagram illustrating a variation of the embodiments of FIG. 6A, in which a virtual user interface (vUI) renderer is provided.

FIG. 7 is a block diagram illustrating some of the components of a physical surface detection engine according to an example.

FIG. 8 is a block diagram illustrating some of the components of a physical object detection engine according to an example.

FIG. 9 is a block diagram illustrating components of a vUI engine according to an example.

FIG. 10 is a flow diagram illustrating an example process carried out by a HMD control system to provide a vUI according to an embodiment.

### DETAILED DESCRIPTION

Aspects of the embodiments are directed to a virtual reality (VR) or augmented reality (AR) processing system that provides its user an interface with which to explore, or interact with, a 3D virtual environment (VE). Current approaches provide several ways to interact: one basic way is to provide a sight, or crosshair, in the center of the field of view. The user may move their head until the crosshair is pointing at the desired virtual actuator, such as a button, and a counter starts counting until the button is clicked. This simple approach is limited to a single point of interaction at a time, and every action takes more time since the user waits for the timer for each selection event. It is also prone to false positives since the user might just be looking at the UI without the intention of selecting an item. More sophisticated controls include specialized physical input devices, or computer vision-based hand tracking solutions. While the physical devices may offer haptic feedback and relatively high accuracy, they limit the user's movements since the user holds the device in their hands at any given moment. On the other hand, although computer vision-based solutions offer more freedom of movement, they lack haptic feedback for the user and might be less accurate for complex UI systems.

Some aspects of the embodiments offer a solution for interacting with VR/AR applications that supports freedom of movement for the user while providing haptic feedback for the user in the physical (real world) environment, and high accuracy interpretation of the user's actuations of the virtual user-input controls. One such approach combines input data from inertial sensors of the HMD, an outward-facing depth-sensing camera on the HMD, hand-tracking algorithms and surface-detection algorithms, as well as user-input interactions with a virtual touchscreen that may be virtually overlaid on physical surfaces of the real-world environment of the user. In the VE, the user may interact with the virtual touchscreen in a manner similar to that as they would with a regular, real-world touchscreen. At the same time, the physical location of the user in the real world may be determined in order to set or change the virtual scenario or context displayed in the VE. Thus, the virtual user interface may adapt to where the user is located, and what actions the user may be taking, to display or hide certain virtual user-interface components, for instance.

In some embodiments, use of the outward-facing depth-sensing camera enables overlaying of the virtual touchscreen onto physical real-world surfaces of the physical environment (PE) in which the user is located. In addition, some embodiments further employ the depth-sensing camera to detect the positioning and manipulation of the user's hand to recognize the user's interaction with the virtual touchscreen. In related embodiments, the user's hand is rendered in the VE in juxtaposition with virtual objects and surfaces, such that the hand may occlude those objects and surfaces as an actual hand would be perceived by the user in the real world.

Aspects of the embodiments may be implemented as part of a computing platform. The computing platform may be one physical machine, or may be distributed among multiple physical machines, such as by role or function, or by process thread in the case of a cloud computing distributed model. In various embodiments, aspects of the invention may be configured to run in virtual machines that in turn are executed on one or more physical machines. For example, the computing platform may include a processor-based system located on a HMD device; it may include a stand-alone computing device such as a personal computer, smartphone, tablet, remote server, etc., or it may include some combination of these. It will be understood by persons of skill in the art that features of the invention may be realized by a variety of different suitable machine implementations.

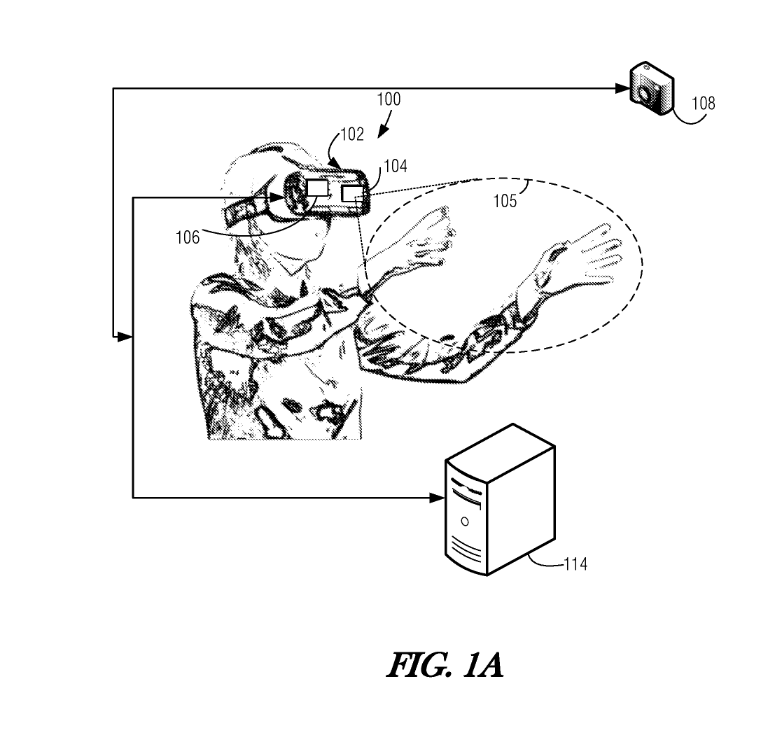

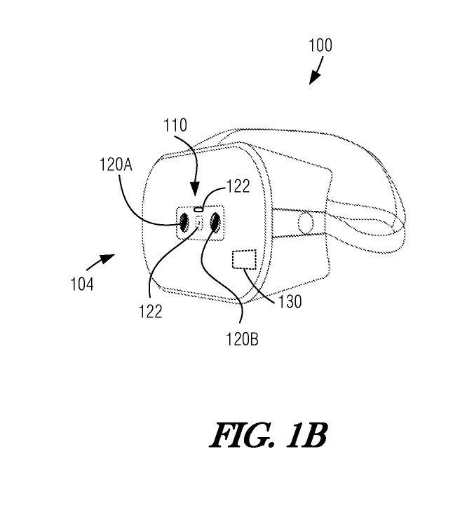

FIG. 1A is a high-level system diagram illustrating some examples of hardware components of a VR system that may be employed according to some aspects of the embodiments. HMD device 100 to be worn by the user includes display 102 facing the user's eyes. In various embodiments, display 102 may include stereoscopic, autostereoscopic, or virtual 3D display technologies. In a related embodiment, the HMD device 100 may have another form factor, such as smart glasses, that offer a semi-transparent display surface.

In the embodiment depicted, HMD device 100 may include a set of sensors 104, such as motion sensors to detect head movement, eye-movement sensors, and hand movement sensors to monitor motion of the user's arms and hands in monitored zone 105.

HMD device 100 also includes a processor-based computing platform 106 that is interfaced with display 102 and sensors 104, and configured to perform a variety of data-processing operations that may include interpretation of sensed inputs, virtual-environment modeling, graphics rendering, user-interface hosting, other output generation (e.g., sound, haptic feedback, etc.), data communications with external or remote devices, user-access control and other security functionality, or some portion of these, and other, data-processing operations.

The VR system may also include external physical-environment sensors that are separate from HMD device 100. For instance, camera 108 may be configured to monitor the user's body movements including limbs, head, overall location within the user's physical space, and the like. Camera 108 may also be used to collect information regarding the user's physical features. In a related embodiment, camera 108 includes three-dimensional scanning functionality to assess the user's physical features. The external physical-environment sensors may be interfaced with HMD system 100 via a local-area network, personal-area network, or interfaced via device-to-device interconnection. In a related embodiment, the external physical-environment sensors may be interfaced via external computing platform 114.

External computing platform 114 may be situated locally (e.g., on a local area network, personal-area network, or interfaced via device-to-device interconnection) with HMD device 100. In a related embodiment, external computing platform 114 may be situated remotely from HMD device 100 and interfaced via a wide-area network such as the Internet. External computing platform 114 may be implemented via a server, a personal computer system, a mobile device such as a smartphone, tablet, or some other suitable computing platform. In one type of embodiment, external computing platform 114 performs some or all of the functionality of computing platform 106 described above, depending on the computational capabilities of computing platform 106. Data processing may be distributed between computing platform 106 and external computing platform 114 in any suitable manner. For instance, more computationally-intensive tasks, such as graphics rendering, user-input interpretation, 3-D virtual environment modeling, sound generation and sound quality adaptation, and the like, may be allocated to external computing platform 114. Regardless of whether, and in what manner, the various VR system functionality is distributed among one or more computing platforms, all of the (one or more) computing platforms may collectively be regarded as sub-parts of a single overall computing platform in one type of embodiment, provided of course that there is a data communication facility that allows the sub-parts to exchange information.

FIG. 1B is a diagram illustrating sensors 104 of HMD 100 in greater detail according to an example embodiment. Outward-facing optical sensors 110 include stereoscopic infrared cameras 120A and 120B, along with a red-green-blue (RGB) camera 122. In a related embodiment, a laser projector 124 is also provided to assist with depth measurement. In another example embodiment, other types of sensors may be provided, such as RADAR, millimeter-wave, ultrasonic, or other types of proximity sensors.

Sensors 104 also include one or more position or motion sensors 130, such as an accelerometer, a gyroscope or other inertial sensor, a magnetometer (e.g., compass), or the like.

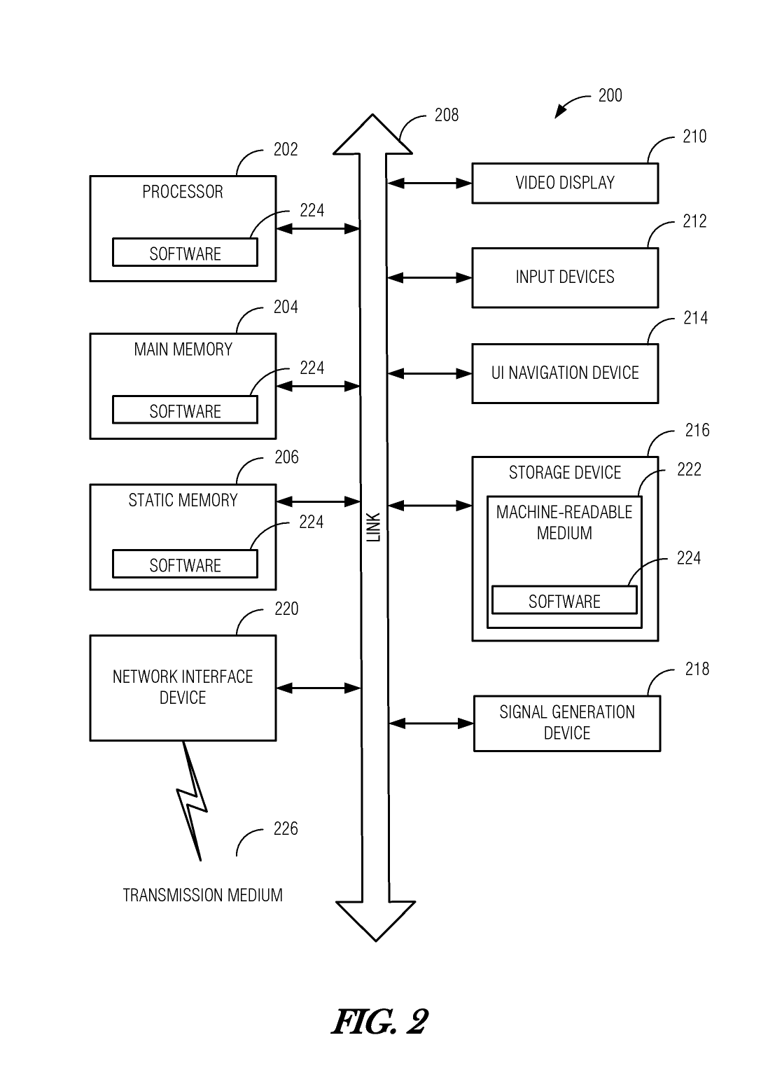

FIG. 2 is a block diagram illustrating a computing platform in the example form of a general-purpose machine. In certain embodiments, programming of the computing platform 200 according to one or more particular algorithms produces a special-purpose machine upon execution of that programming. In a networked deployment, the computing platform 200 may operate in the capacity of either a server or a client machine in server-client network environments, or it may act as a peer machine in peer-to-peer (or distributed) network environments. Computing platform 200, or some portions thereof, may represent an example architecture of computing platform 106 or external computing platform 114 according to one type of embodiment.

Example computing platform 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computing platform 200 may further include a video display unit 210, input devices 212 (e.g., a keyboard, camera, microphone), and a user interface (UI) navigation device 214 (e.g., mouse, touchscreen). The computing platform 200 may additionally include a storage device 216 (e.g., a drive unit), a signal generation device 218 (e.g., a speaker), and a network interface device (NID) 220.

The storage device 216 includes a machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computing platform 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

NID 220 according to various embodiments may take any suitable form factor. In one such embodiment, NID 220 is in the form of a network interface card (NIC) that interfaces with processor 202 via link 208. In one example, link 208 includes a PCI Express (PCIe) bus, including a slot into which the NIC form-factor may removably engage. In another embodiment, NID 220 is a network interface circuit laid out on a motherboard together with local link circuitry, processor interface circuitry, other input/output circuitry, memory circuitry, storage device and peripheral controller circuitry, and the like. In another embodiment, NID 220 is a peripheral that interfaces with link 208 via a peripheral input/output port such as a universal serial bus (USB) port. NID 220 transmits and receives data over transmission medium 226, which may be wired or wireless (e.g., radio frequency, infra-red or visible light spectra, etc.), fiber optics, or the like.

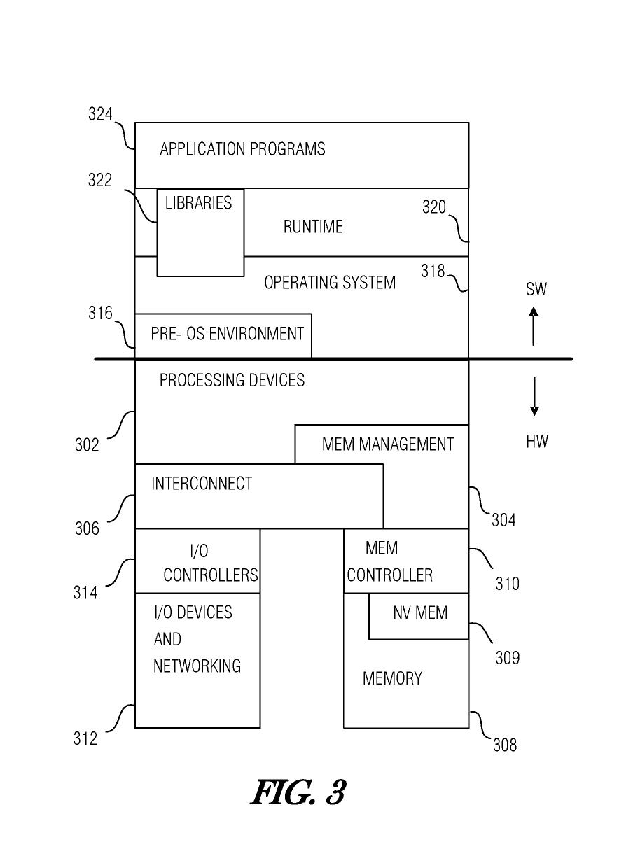

FIG. 3 is a diagram illustrating an exemplary hardware and software architecture of a computing device such as the one depicted in FIG. 2, in which various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc., each having one or more processor cores, are interfaced with memory management device 304 and system interconnect 306. Memory management device 304 provides mappings between virtual memory used by processes being executed, and the physical memory. Memory management device 304 may be an integral part of a central processing unit which also includes the processing devices 302.

Interconnect 306 includes a backplane such as memory, data, and control lines, as well as the interface with input/output devices, e.g., PCI, USB, etc. Memory 308 (e.g., dynamic random access memory—DRAM) and non-volatile memory 309 such as flash memory (e.g., electrically-erasable read-only memory—EEPROM, NAND Flash, NOR Flash, etc.) are interfaced with memory management device 304 and interconnect 306 via memory controller 310. This architecture may support direct memory access (DMA) by peripherals in one type of embodiment. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding I/O controllers 314.

On the software side, a pre-operating system (pre-OS) environment 316, which is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, is responsible for initiating the launching of the operating system, but also provides an execution environment for embedded applications according to certain aspects of the invention.

Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) engine that facilitates interaction with the user via peripheral devices such as a monitor, keyboard, mouse, microphone, video camera, touchscreen, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries, dynamic linked libraries (DLLs), for example. Libraries 322 may be integral to the operating system 318, runtime system 320, or may be added-on features, or even remotely-hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

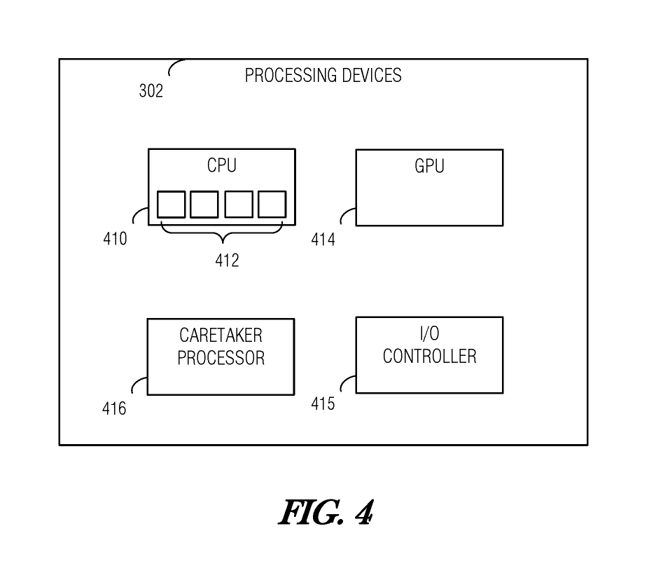

FIG. 4 is a block diagram illustrating processing devices 302 according to one type of embodiment. CPU 410 may contain one or more processing cores 412, each of which has one or more arithmetic logic units (ALU), instruction fetch unit, instruction decode unit, control unit, registers, data stack pointer, program counter, and other essential components according to the particular architecture of the processor. As an illustrative example, CPU 410 may be a x86-type of processor. Processing devices 302 may also include a graphics processing unit (GPU) 414. In these embodiments, GPU 414 may be a specialized co-processor that offloads certain computationally-intensive operations, particularly those associated with graphics rendering, from CPU 410. Notably, CPU 410 and GPU 414 generally work collaboratively, sharing access to memory resources, I/O channels, etc.

Processing devices 302 may also include caretaker processor 416 in one type of embodiment. Caretaker processor 416 generally does not participate in the processing work to carry out software code as CPU 410 and GPU 414 do. In one type of embodiment, caretaker processor 416 does not share memory space with CPU 410 and GPU 414, and is therefore not arranged to execute operating system or application programs. Instead, caretaker processor 416 may execute dedicated firmware that supports the technical workings of CPU 410, GPU 414, and other components of the computing platform. In one type of embodiment, caretaker processor is implemented as a microcontroller device, which may be physically present on the same integrated circuit die as CPU 410, or may be present on a distinct integrated circuit die. Caretaker processor 416 may also include a dedicated set of I/O facilities to enable it to communicate with external entities. In one type of embodiment, caretaker processor 416 is implemented using a manageability engine (ME) or platform security processor (PSP). Input/output (I/O) controller 415 coordinates information flow between the various processing devices 410, 414, 416, as well as with external circuitry, such as a system interconnect.

Examples, as described herein, may include, or may operate on, logic or a number of components, engines, or engines, which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more computing platforms (e.g., a standalone, client or server computing platform) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time.

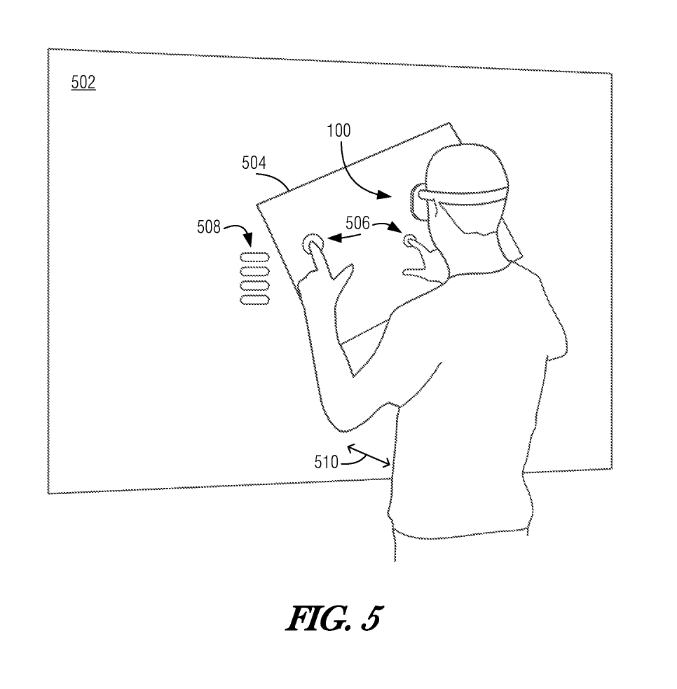

FIG. 5 is a diagram illustrating an example operational scenario involving HMD device 100 according to some embodiments. In this figure, objects of the PE are shown with virtual objects of the VE to illustrate their interplay. As depicted, the user is positioned proximate (e.g., within reach) of a physical surface 502. Physical surface 502 is illustrated as a vertical wall in this example, though it will be understood that physical surface 502 may be a horizontal surface, such as a table top. In addition, physical surface 502 may be part of a physical object, such as a door, appliance or other article of manufacture, or a part of the user's body, such as one of the user's hands, thigh, etc. Physical surface 502 may be flat, or it may have a contour or more complex shape.

Depending on whether HMD device 100 is a VR or AR device, the user may or may not have direct visibility of physical surface 502. In either case, however, HMD device 100 creates a virtual user interface (vUI) in the VE that includes an information display 504 and set of one or more virtual touch controls 506, 508. Information display 504 and virtual touch controls 506, 508 are positioned in virtual space relative to the virtual perspective of the user in the VE to coincide with the physical surface 502 in the PE relative to the user's physical position. Hence, information display 504 and virtual touch controls 506, 508 are virtually overlaid on physical surface 502. As a result, from the user's perspective, touch interaction with information display 504 or virtual touch controls 506, 508 involves the user physically touching surface 502, which provides haptic feedback for the user. Thus, physical surface 502 is used as the touch surface for the vUI. In a sense, the vUI has a virtual component that is observable only in the VE, and a physical component present in the PE, which may or may not be represented in the VE according to various embodiments.

In a related embodiment, HMD device 100 takes into account the movement of the user to keep the information display 504 and the virtual touch controls 506, 508 positioned in the same virtual location overlaid on the same location of physical surface 502, from the user's perspective. Accordingly, as the user's perspective varies due to the user's head movement or overall movement in the PE, which is recognized and modeled as similar movement in the VE, the rendering of information display 504 and display of the virtual touch controls 506, 508 is adjusted to vary their perspective view commensurately.

Virtual touch controls 506 are integrated with information display 504, and may support an input to allow the user to move, rotate, or re-size virtual display 504, for example. Virtual controls 508 may be arranged independently from information display 504, and their positioning or size may be separately defined from those of information display 504.

In a related embodiment, positioning 510 of the user relative to the physical surface 502 is taken into account as a condition for displaying information display 504 and the virtual touch controls 506, 508. For instance, when distance 510 is greater than a predefined value roughly corresponding to the user's reach (e.g., 50-100 cm), information display 504 and virtual touch controls 506, 508 may not be displayed; however, when the user approaches surface 502, information display 504 and virtual touch controls 506, 508 may be displayed.

In a related embodiment, sensors 104 and their corresponding processing circuitry are configured to track the user's hands, and to detect movements or gestures that are aligned with virtual touch controls 506, 508 as being the user's actuation of those controls in the VE. In an example, movement of the user's hand in a direction away from the user and towards surface 502, followed by an abrupt stop of the hand movement along that direction, in the vicinity of information display 504 and virtual touch controls 506, 508, which his indicative of the user's hand making contact with surface 502, may be interpreted in the VE as the user's actuation of virtual touch controls 506 or 508. Further movement along the plane of surface 502 may be interpreted as a dragging gesture, and movement of the user's hand back towards the user may be interpreted as the user's disengagement from virtual touch controls 506, 508, for example. As such, a variety of gestures may be tracked and identified using sensors 104, including clicking, double-clicking, dragging, multi-touch pinching, rotation, and the like.

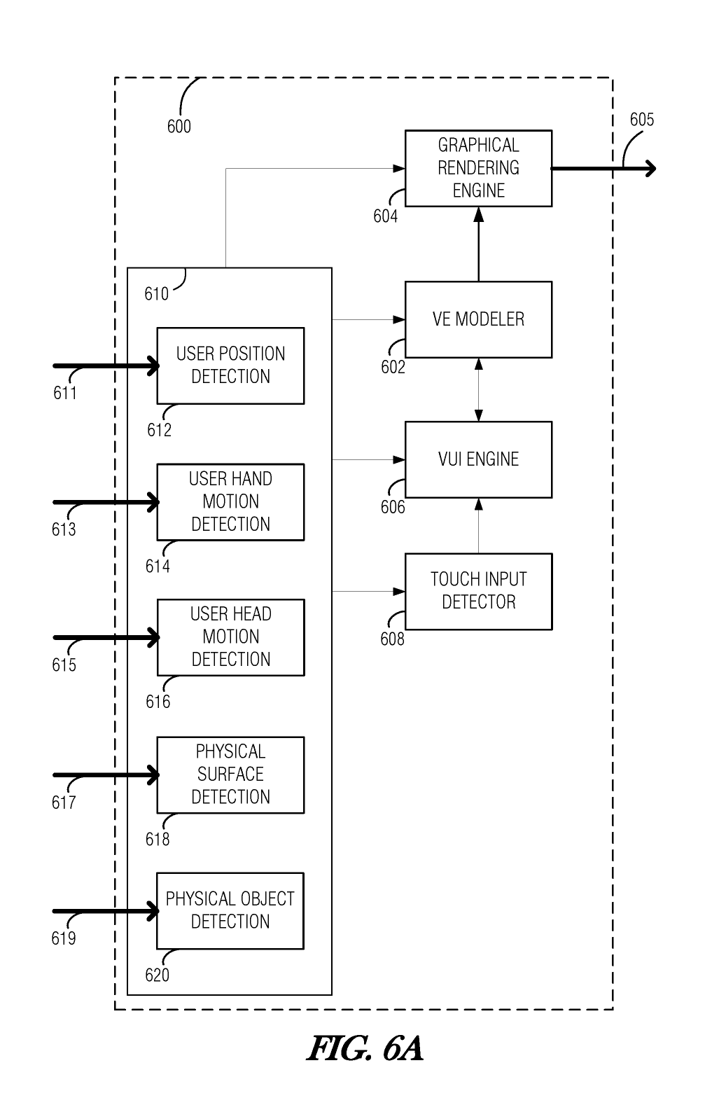

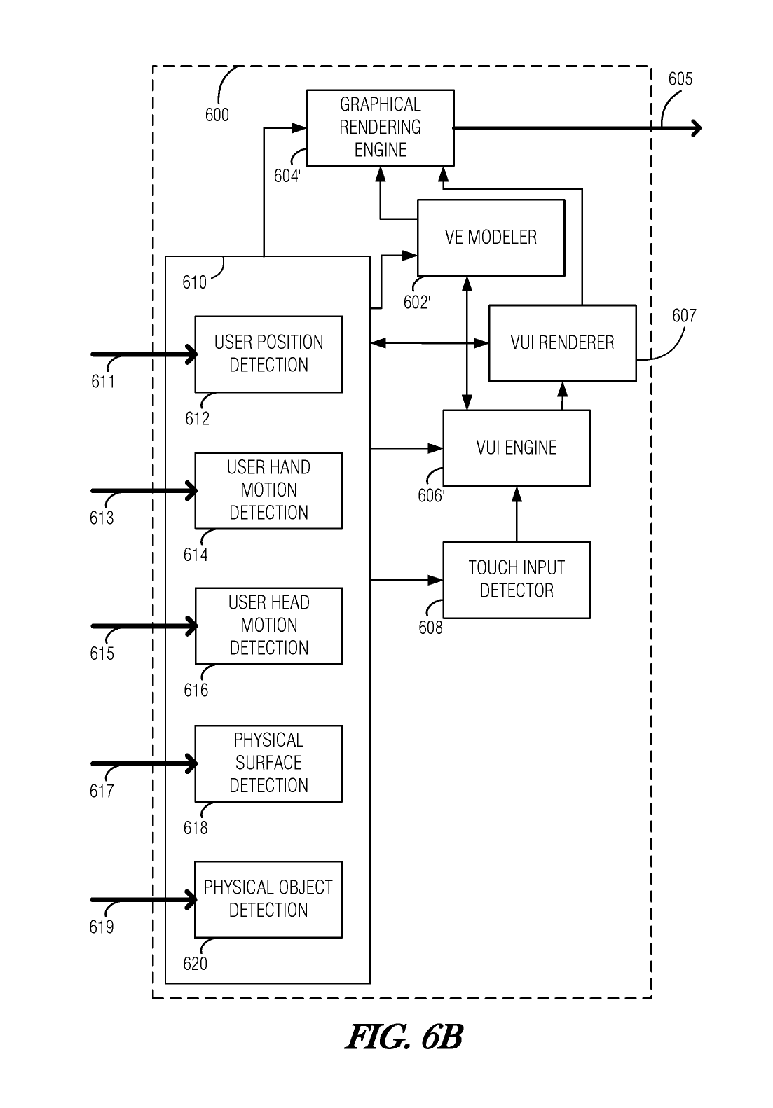

FIG. 6A is a block diagram illustrating various engines implemented on a computing platform 600, according to various embodiments, to make a special-purpose machine for executing a VE that interacts with a user who is located in a PE. As depicted, computing platform 600 includes virtual-environment modeler 602, which is constructed, programmed, or otherwise configured, to model a 3D VE, including virtual objects, structures, forces, sound sources, and laws of physics, that may be specific to the particular 3D VE. Graphical rendering engine 604 is constructed, programmed, or otherwise configured, to render perspective-view imagery of parts of the VE, such as from the user's vantage point, and provides the perspective-view imagery output 605 to a display output interface which, in turn, is coupled to a HMD device or other suitable display on which the user views the VE.

VE modeler 602 receives input relating to the user and the user's actual environment from PE monitor 610. In the embodiment depicted, PE monitor 610 includes user position detection engine 612, user hand motion detection engine 614, user head motion detection engine 616, physical surface detection engine 616, and physical object detection engine 620.

User position detection engine 612 is constructed, programmed, or otherwise configured, to receive position or motion-related input 611 from sensors that may be integrated with a HMD, placed in the PE, or some combination of HMD-mounted and stationary, sensors. Examples of such sensors include an accelerometer, gyroscope or other inertial sensor, magnetometer (e.g., compass), any of which may be incorporated in the HMD. In addition, sensors external to the HMD may provide position or motion information. For instance, a camera, particularly a camera with 3D functionality, may be used to assess a user's motion and orientation. An on-board camera mounted on the HMD and positioned to capture the user's actual surroundings, may also be used to assess certain types of user's motion, for example, whether the user turns his or her head. User position detection sensor 612 may be configured to process a variety of sensor inputs from different types of sensors, to detect the position of the user, or the nature and extent of motion of the user, in the PE.

In one type of embodiment, the user's position and motion is assessed with reference to certain objects or fiducial marks or other features defined in the PE. In another example, inertial sensing may be used to assess motion and position of the user. Various combinations of these types of sensing are also contemplated in other examples.

User hand motion detection engine 614 is constructed, programmed, or otherwise configured, to receive input 613 from HMD-mounted, or physical-environment mounted sensors, and process that input to recognize the user's hands, and their motion and gestures, such as pointing, tracking, waving, etc. Input 613 may include 3D-sensed optical input, for instance, using the stereoscopic camera of the HMD.

User head motion detection engine 616 is constructed, programmed, or otherwise configured, to ascertain motion and positioning of the HMD device, as worn and moved, by the user, based on HMD motion input 615. Input 615 may include inertial sensing, optical sensing, and the like, similar to motion-related input 611, except that HMD motion input 615 is particularized to motion of the HMD device, rather than the overall motion of the user in the PE.

Physical surface detection engine 618 is constructed, programmed, or otherwise configured, to process input 617 to detect the presence, and location, of various surfaces in the PE. Input 617 may include 3D visual input from the stereoscopic cameras, infrared cameras, or some combination, of HMD-mounted sensors. Input 617 may also include input from the PE-mounted sensors. Physical surface detection engine includes a surface-detection algorithm and computing hardware to execute that algorithm. Any suitable surface-detection algorithm may be used in accordance with various embodiments utilizing optical sensing, millimeter-wave sensing, ultrasonic sensing, or the like.

Physical object detection engine 620 is constructed, programmed, or otherwise configured, to process input 619 to detect the presence, and location, of various objects in the PE. Objects may include architectural features such as doors, windows, stairs, columns, etc., as well as furniture such as tables, chairs, sofas, shelves, wall decorations, and other objects typically found in a user's PE. Detectable objects may also include objects that may be represented in the VE, which may include architectural and furniture objects, as well as interactive or controllable objects, such as appliances, thermostat, electrical/electronic devices, and the like. Physical object detection engine 620 includes an object database containing records of known objects in terms of their features that are observable via the available sensors in the PE and on the HMD. Physical object detection engine 620 may also include an object-detection algorithm and computing hardware to execute that algorithm. Any suitable object-detection algorithm may be used in accordance with various embodiments utilizing optical sensing, millimeter-wave sensing, ultrasonic sensing, or the like.

Virtual user interface (vUI) engine 606 is constructed, programmed, or otherwise configured, to ascertain the user's activity context in the VE as it relates to the vUI, along with the user's position relative to usable surfaces in the PE and, based on that assessment, to determine placement (relative to the user's virtual location) and appearance of the vUI in the VE. Accordingly, vUI engine 606 passes vUI configuration and placement information to VE modeler 602, which in turn incorporates the vUI details into the model of the VE.

In a related embodiment, vUI engine 606 may receive a portion of the modeled VE from VE modeler 602. For instance, vUI engine 606 may receive a 3D model of the objects and surfaces within the user's current field of view, and their respective distances from the user, from VE modeler 602. Based on this information, vUI engine 606 may determine suitable placement of the vUI in the VE.

Touch input detector 608 is constructed, programmed, or otherwise configured, to detect actions of the user as they relate to operation of the vUI, and pass that assessment to vUI engine 606. Detection of the user's actions is based on the output of each of engines 612, 614, 616, 618, and 620. Accordingly, as the user touches the physical surface detected by engine 618, or an object detected by engine 620, touch input detector 608 indicates to vUI engine 606 the user has made touch gestures, and the precise locations of the user's touches. In turn, vUI engine 606 exchanges the details of the user's touch gestures with VE modeler 602, which may further effect responses in the VE to the vUI input.

FIG. 6B is a diagram illustrating a related embodiment to the one described above with reference to FIG. 6A. In the embodiment of FIG. 6B, vUI renderer 607 is provided, with accommodations for vUI renderer 607 provided by vUI engine 606, VE modeler 602′, and graphical rendering engine 604′. vUI renderer 607 is constructed, programmed, or otherwise configured, to perform graphical rendering of the vUI in the HMD display distinctly from VE modeler 602′. Hence, in this embodiment, the VUI is not modeled as part of the modeled VE; instead, it is treated as a separate layer that resides on top of the VE as seen from the perspective of the wearer of the HMD. Accordingly, VUI renderer receives placement instructions for the location, size, and angle with which to display the vUI, from vUI engine 606′. vUI renderer 607 may work in combination with graphical rendering engine 604′ to incorporate the layer containing the vUI rendering into a layer stack that may be managed by graphical rendering engine 604′.

In addition, vUI renderer 607, receives user position, user hand motion, and user head motion information from PE monitor 610. vUI renderer 607 is further configured to move the vUI display within the HMD in response to the user's body motion and head motion, such that, from the user's perspective, the vUI appears stationary.

In a related embodiment, vUI renderer 607 is configured to occlude the display of the vUI in the HMD when the user's hand is placed, or passes, in front of the displayed vUI to more realistically represent the vUI in the VE. Accordingly, the user hand motion information from user hand motion detection engine 614 of PE monitor 610 is used to determine the location of the user's hands. Notably, in some examples, vUI renderer 607 does not render the user's hands in detail in the HMD; rather, vUI renderer 607 omits portions of the vUI in those regions where the user's hands have been determined to be located at each corresponding sampling interval. This approach allows VE modeler 602′, graphical rendering engine 604′, or some combination of these components, to handle the display and rendering of the user's hands.

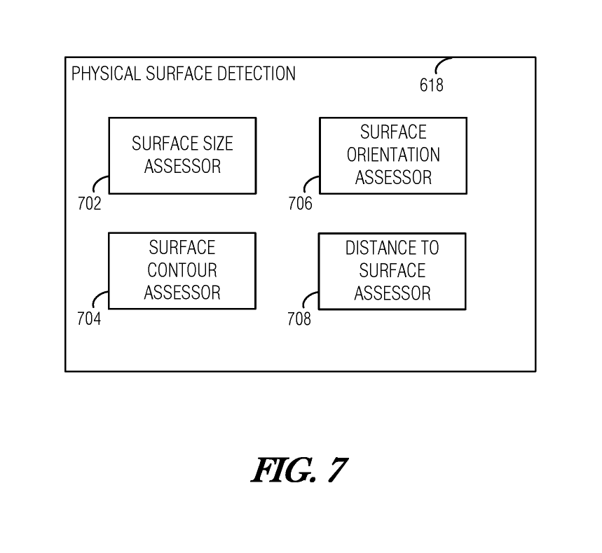

FIG. 7 is a block diagram illustrating some of the components of physical surface detection engine 618 according to an example. As depicted, physical surface detection engine 618 includes a surface size assessor 702 that is constructed, programmed, or otherwise configured, to find the peripheral boundaries of objects or structures within the field of view and within a defined proximity of the HMD to determine the size of each object's or structure's surface. Surface contour assessor 704 is constructed, programmed, or otherwise configured, to measure the curvature of the surface using a 3D camera provided on the HMD, for example. Surface orientation assessor 706 is constructed, programmed, or otherwise configured, to determine the orientation of the surface (e.g., vertical, horizontal, etc.) and the position and direction of the 3D vector that is normal to the surface using data captured by the 3D camera of the HMD, PE-located sensors, or some combination of these, for example. Distance to surface assessor 708 is constructed, programmed, or otherwise configured, to measure the distance between the HMD and the surface using the 3D camera of the HMD, for example. A combination of the assessments made by engines 702-708 is used to locate, and characterize a surface that may be used by VUI engine 606 and touch input detector 608.

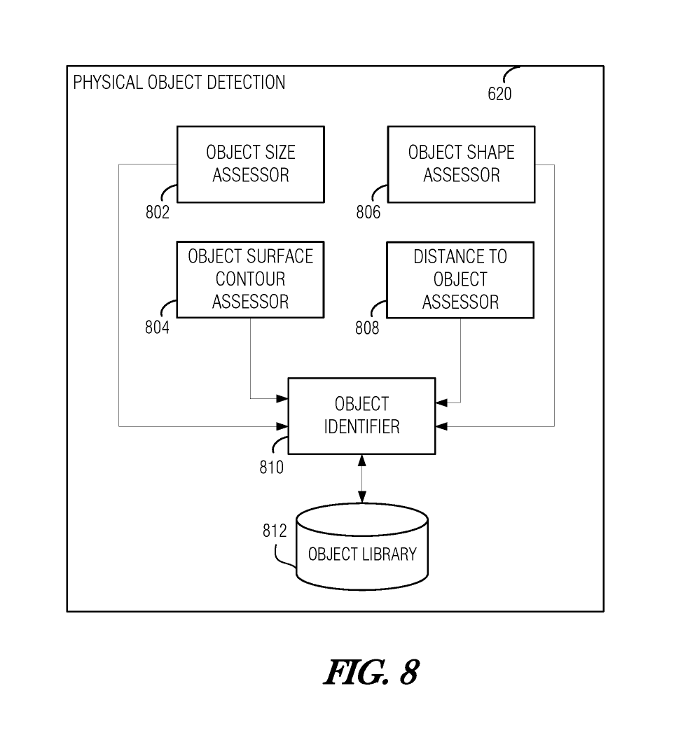

FIG. 8 is a block diagram illustrating some of the components of physical object detection engine 620 according to an example embodiment. Object size assessor 802 is constructed, programmed, or otherwise configured, to find the peripheral boundaries of objects within the field of view and within a defined proximity of the HMD to determine the size of each object. Object surface contour assessor 804 is constructed, programmed, or otherwise configured, to measure the curvature of the surfaces of objects using a 3D camera provided on the HMD, for example. Object shape assessor 806 is constructed, programmed, or otherwise configured, to determine the shape of objects using the 3D camera of the HMD based on the peripheral boundaries of the object. Distance to object assessor 808 is constructed, programmed, or otherwise configured, to measure the distance between the HMD and the object using the 3D camera of the HMD, for example. Object identifier 810 is constructed, programmed, or otherwise configured, to collect assessments from engines 802-808, and to identify individual analyzed objects based on object library 812 containing characteristics of various known objects.

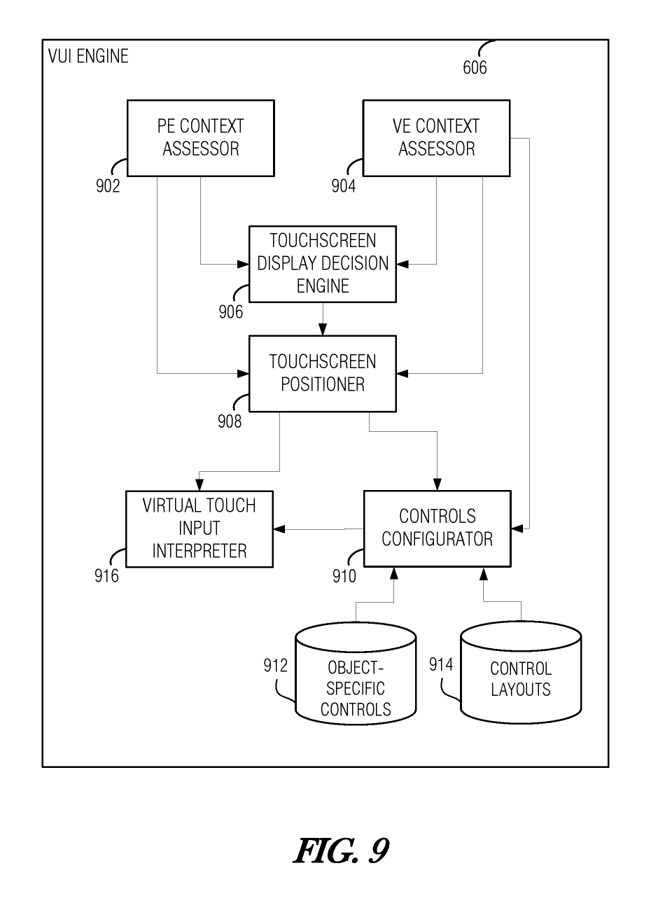

FIG. 9 is a block diagram illustrating components of vUI engine 606 according to an example embodiment. PE context assessor 902 is constructed, programmed, or otherwise configured, to assess the user's activity in the PE. The functionality of PE context assessor 902 may be relevant in an augmented-reality (AR) system in which the user interacts with objects in the PE. In this type of application, PE context assessor 902 may determine, based on the detection of objects and surfaces, motion of the user, movement of the user's hands, and other sensed and assessed activity, whether the user is taking actions to interact with certain objects located in the PE. For instance, if a user wearing a HMD approaches a wall in the PW on which a thermostat is mounted, and if the user reaches toward the thermostat, PE context assessor 902 may generate an indication that the user is intending to operate the thermostat. PE context assessor 902 may also have applications in a VR scenario, where the user is not purposefully interacting with objects or surfaces in the PE, but may nonetheless be in proximity of various objects that may or may not interfere with the virtual representation of the VE.

PE context assessor 902 receives as its input the various detections or PE monitor 610, which in turn are based on sensed events occurring in the PE. Based on this input, and on one or more decision algorithms (e.g., heuristics, classification, artificial neural network, etc.), PE context assessor 902 may determine such contextual events as whether the user approaches or initiates interaction with various objects or structures. The output of PE context assessor 902 may indicate such assessments as user wearing HMD approaches object located at coordinates (x, y, z), user wearing HMD reaches towards object, etc. These assessments may be indicated numerically, and may be accompanied by, or represented by, a confidence score of the assessment.

VE context assessor 904, depicted as a component of VUI engine 606, may also be incorporated as a component of VE modeler 602 in various example embodiments. VE context assessor 904 is constructed, programmed, or otherwise configured, to determine user activity in the VE as it relates to the user's interaction with controllable objects in the VE. As an illustrative example, in the case where the VE models a kitchen environment, each of the various virtual appliances may be individually controllable. Accordingly, VUI engine 606 operates to assess whether the user is taking actions to control any of these given appliances. The input to VE context assessor 904 is provided from the VE model being processed by VE modeler 602.

As illustrated in the example of FIG. 9, the outputs of PE context assessor 902 and VE context assessor 904 are fed to touchscreen display decision engine 906, and touchscreen positioner 908. Touchscreen display decision engine 906 is constructed, programmed, or otherwise configured, to determine, based on the PE context assessment by PE context assessor 902, or VE context assessment by VE context assessor 904, when to display a vUI in the HMD to be viewable by the user. The determination of when to display the vUI may be based on the user's position in the PE, particularly relative to surfaces having a suitable size, shape, and orientation, to be used as a physical surface for a vUI as its physical component.

Touchscreen positioner 908 is constructed, programmed, or otherwise configured, to determine the location within the VE to display the vUI. This determination is also based on the PE context assessment by PE context assessor 902, or VE context assessment by VE context assessor 904. In one example embodiment, the decision by touchscreen positioner 908 as to the location in which to display the virtual touchscreen in the VE is based in part on the user's position relative to a suitable surface within the PE to be used as the physical component of the vUI. In a related embodiment, touchscreen positioner 908 may cause VE modeler 602 to adjust the virtual position of the user in the VE so that a virtual control panel of the vUI appears as part of a virtual object that is positioned relative to the user's perspective coincident with the physical surface in the PE.

In another example, the virtual control panel of the vUI is displayed as a newly-materialized virtual object (e.g., a touchscreen device) at a selected arbitrary location within the context of the VE, which may be independent of any other virtual object or surface. For instance, the virtual control panel of the vUI may appear as a floating object in the virtual space of the VE, or as a virtual object anchored to an existing virtual structure or virtual object in the VE (e.g., suspended from the virtual ceiling, or supported by a virtual post from the virtual floor).

Controls configurator 910 is constructed, programmed, or otherwise configured, to determine the arrangement of the virtual controls of the vUI. This determination may be based on the VE context, as determined by VE context assessor 904. For instance, if the user in the VE is approaching a virtual microwave oven, a set of microwave-oven controls may be displayed in the vUI; whereas if the user in the VE is approaching a thermostat, a different set of controls, such as those corresponding to a thermostat, would be displayed in the vUI. Accordingly, as depicted in the illustrated example, controls configurator 910 may access object-specific controls database 912 to determine the set of controls appropriate for the type of virtual object with which the user is interfacing in the VE, as provided by VE context assessor 904. For example, in the case of a thermostat, the controls may include temperature up/down controls, time display and time setting controls, schedule programming controls, zone selection, measured temperature display, set temperature display, and the like. Controls configurator 910 may also access control layouts database 914, which may contain specific types of control layouts (e.g., virtual sliders, radio buttons, keypads, and the like, along with the relative positioning of these controls). Accordingly, controls configurator 910 may operate to look up the appropriate set of object-specific controls relating to a particular virtual object with which the user is interacting in the VE, it may look up a suitable appearance and relative positioning for those controls based on control layouts database 914. The controls configuration is provided to VE modeler 602, which places the vUI in the VE.

Virtual touch input interpreter 916 determines whether, and how, the controls of the vUI are manipulated by the user. To this end, virtual touch input interpreter 916 reads as its input the controls configuration from controls configurator 910, as well as the vUI position information from touchscreen positioner 908. Also virtual touch input interpreter 916 obtains user hand motion information as determined by user hand motion detection engine 614, and applies a gesture-recognition algorithm to the hand motion to ascertain when, and where, the user's hand contacted and manipulated the vUI controls. The ascertained control manipulations are fed to VE modeler 602 such that the VE model may model the virtual user input via the vUI, and the VE response to that input.

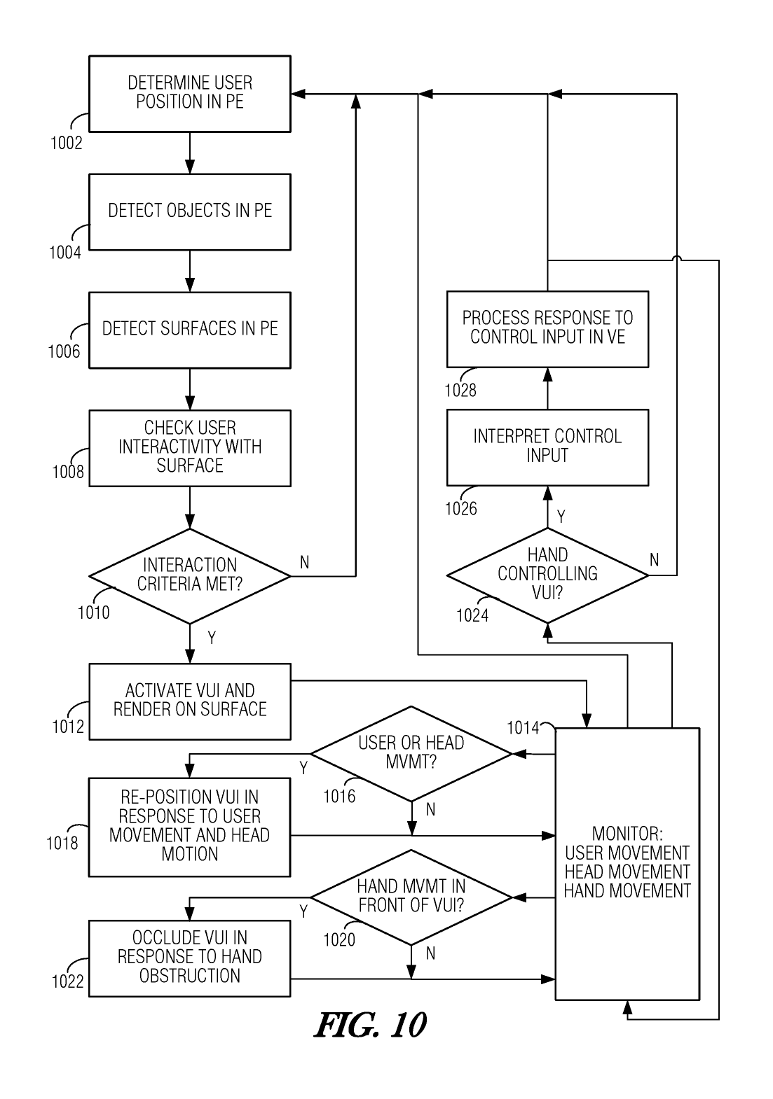

FIG. 10 is a flow diagram illustrating an example process carried out by a HMD control system to provide a vUI according to an embodiment. At 1002, the system determines the user's position within the PE. At 1004, objects in the PE are detected based on their proximity to the HMD-mounted cameras, for example. At 1006, surfaces in the PE are analyzed, and suitable surfaces for a vUI are identified. At 1008, the user's interactivity with a suitable surface is assessed. This assessment may be based on the 3D measurements made by cameras mounted on the HMD, for example, and on the user's movements. At 1010, predefined interaction criteria is applied to check whether the user is able to, or intends to, make use of the surface as a vUI. The user's ability to make use of the surface may be simply based on the user's physical proximity (e.g., arm's reach) to the surface. User intent may be inferred based on the user's motion towards or away from the surface, the user's touching of the surface, or other user behaviors. In a related embodiment, the interaction criteria may be dynamic, or not clearly defined, such as in the case of machine-learning systems (e.g., neural networks, classifiers, genetic algorithms, etc.). If the interaction criteria is not met, the process loops back to repeat operations 1002-1008, where the user's movement in the PE, physical objects and surfaces, and the level of user interactivity with the surfaces, continue to be monitored.

If decision 1010 determines that the user is sufficiently interacting with the surface to merit displaying the vUI, the process advances to 1012, where the vUI is activated and displayed to appear on the surface from the user's perspective in the HMD. While the vUI is displayed, operation 1014 monitors the user's position (user movement) in the PE, the user's head movement in the PE, and the user's hand movement in the PE. If user positional movement or head movement is detected at 1016, the vUI is re-positioned and re-sized in the HMD to appear stationary (e.g., fixed in its virtual position in the VE) at 1018. If the user's hand movement is detected in the PE such that the hand is between the user's face and the physical surface corresponding to the virtual position of the vUI at 1020, the vUI is occluded commensurately with the hand obstruction at 1022.

While the vUI is displayed in the VE, decision 1024 determines, based on the user's hand movement in the PE, whether those movements are tantamount to purposeful manipulation of the vUI controls. For instance, if the user's hand is positioned in a pointing gesture with the index finger extended, and moved to contact the surface with the index finger, this may be interpreted as actuation of the vUI control corresponding to the virtual position of the index finger on the vUI. Accordingly, at 1026, the control input is interpreted based on the touch, or based on a touch-gesture such as a long press, a drag, a pinch, a pivot, or the like, and the location of the contact points between the user's hand and the virtual controls of the vUI. At 1028, the control input is processed in the context of the VE to realize the result of activation of the vUI controls. The process then loops to 1014 to continue monitoring the user's actions interacting with the vUI, and to 1002 to continue monitoring the user's general position in the PE.

### Additional Notes & Examples

Example 1 is apparatus for controlling a head-mounted display (HMD) device to be worn by a user in a physical environment, the apparatus comprising a computing platform including processor, data storage, and input/output devices, the computing platform containing instructions that, when executed cause the computing platform to implement: a virtual environment (VE) modeler to model a 3D VE, including a virtual controllable object subject to virtual control input; a physical environment (PE) monitor to detect motion of the position, head, and hands of the user in the PE, and to detect a physical surface in the PE; and a virtual user interface (vUI) engine to determine placement of a vUI in the VE relative to a virtual perspective of the user in the VE, to coincide with the physical surface in the PE relative to the position of the user in the PE, wherein the vUI includes an information display and at least one virtual touch control to produce the virtual control input in response to virtual manipulation of the virtual touch control.

In Example 2, the subject matter of Example 1 optionally includes wherein the PE monitor is to detect the motion of the position, head, and hands of the user in the PE, and to detect a physical surface in the PE, based on output of sensors present in the PE.

In Example 3, the subject matter of any one or more of Examples 1-2 optionally include wherein the virtual manipulation of the virtual touch control corresponds to physical interaction with the physical surface by the user.

In Example 4, the subject matter of Example 3 optionally includes wherein the virtual manipulation of the virtual touch control is detected as a result of physical interaction with the physical surface by the user.

In Example 5, the subject matter of any one or more of Examples 1-4 optionally include a touch input detector to detect actions of the user in the PE relating to user operation of the vUI in the VE.

In Example 6, the subject matter of any one or more of Examples 1-5 optionally include wherein the vUI engine is to control appearance of the vUI in the VE.

In Example 7, the subject matter of any one or more of Examples 1-6 optionally include wherein the PE monitor includes a physical object detection engine to recognize physical objects in the PE.

In Example 8, the subject matter of any one or more of Examples 1-7 optionally include a graphical rendering engine to render perspective-view imagery of parts of the VE from a vantage point of the user, and provides perspective-view imagery output for display on the HMD device.

In Example 9, the subject matter of any one or more of Examples 1-8 optionally include a vUI renderer to perform graphical rendering of a perspective view of the vUI for display on the HMD device.

In Example 10, the subject matter of Example 9 optionally includes wherein the vUI renderer is to adjust the perspective-view graphical rendering of the vUI in response to motion of the user such that the vUI appears fixed in the VE.

In Example 11, the subject matter of any one or more of Examples 9-10 optionally include wherein the vUI renderer is to at least partially occlude the perspective-view graphical rendering of the vUI in response to user hand positioning in the PE between the HMD and a location in the PE corresponding to a location of the vUI in the VE relative to the head of the user.

In Example 12, the subject matter of any one or more of Examples 1-11 optionally include wherein the vUI engine includes a PE context assessor to determine whether movements of the user in the PE represent intended user interaction with the virtual controllable object in the VE.

In Example 13, the subject matter of any one or more of Examples 1-12 optionally include wherein the vUI engine includes a VE context assessor to determine user activity in the VE as it relates to interaction of the user with the virtual controllable object in the VE.

In Example 14, the subject matter of any one or more of Examples 1-13 optionally include wherein the vUI engine includes a touchscreen display decision engine to determine when to display the vUI in the HMD based on a position of the user in the PE relative to the physical surface.

In Example 15, the subject matter of Example 14 optionally includes wherein the touchscreen display decision engine is to further determine when to display the vUI in the HMD based on hand actions of the user relative to the physical surface.

In Example 16, the subject matter of any one or more of Examples 1-15 optionally include wherein the vUI engine includes a controls configurator to determine selection and arrangement of virtual controls of the vUI based on an activity context of the VE.

In Example 17, the subject matter of Example 16 optionally includes wherein the activity context of the VE includes a type determination of the virtual controllable object.

In Example 18, the subject matter of any one or more of Examples 1-17 optionally include wherein the apparatus is incorporated in the HMD device.

In Example 19, the subject matter of any one or more of Examples 1-18 optionally include wherein the HMD device is a virtual-reality device.

In Example 20, the subject matter of any one or more of Examples 1-19 optionally include wherein the HMD device is an augmented-reality device.

In Example 21, the subject matter of any one or more of Examples 1-20 optionally include D camera to detect locations of physical surfaces in the PE relative to the HMD device.

In Example 22, the subject matter of any one or more of Examples 1-21 optionally include a computing platform including a processor, a data store, and input/output facilities, the computing platform to implement the VE modeler, the PE monitor and the vUI engine.

Example 23 is a machine-implemented method for controlling a head-mounted display (HMD) device to be worn by a user in a physical environment (PE), the method comprising: computationally modeling a 3D virtual environment (VE) to include a virtual controllable object subject to virtual control input; and determining placement of a virtual user interface (vUI) in the VE relative to a virtual perspective of the user in the VE, to coincide with the physical surface in the PE relative to the position of the user in the PE, the vUI including an information display and at least one virtual touch control to produce the virtual control input in response to virtual manipulation of the virtual touch control, wherein the determining placement is based on detection of motion of the position, head, and hands of the user in the PE, and on detection of a physical surface in the PE.

In Example 24, the subject matter of Example 23 optionally includes wherein the virtual manipulation of the virtual touch control corresponds to physical interaction with the physical surface by the user.

In Example 25, the subject matter of Example 24 optionally includes wherein the virtual manipulation of the virtual touch control is detected as a result of physical interaction with the physical surface by the user.

In Example 26, the subject matter of any one or more of Examples 23-25 optionally include detecting actions of the user in the PE relating to user operation of the vUI in the VE.

In Example 27, the subject matter of any one or more of Examples 23-26 optionally include varying an appearance of the vUI in the VE.

In Example 28, the subject matter of any one or more of Examples 23-27 optionally include rendering perspective-view imagery of parts of the VE from a vantage point of the user for display on the HMD device.

In Example 29, the subject matter of any one or more of Examples 23-28 optionally include rendering a perspective view of the vUI for display on the HMD device.

In Example 30, the subject matter of Example 29 optionally includes wherein the rendering of the perspective view of the vUI includes adjusting the perspective-view rendering of the vUI in response to motion of the user such that the vUI appears fixed in the VE.

In Example 31, the subject matter of any one or more of Examples 29-30 optionally include wherein the rendering of the perspective view of the vUI includes at least partially occluding the vUI in response to user hand positioning in the PE between the HMD and a location in the PE corresponding to a location of the vUI in the VE relative to the head of the user.

In Example 32, the subject matter of any one or more of Examples 23-31 optionally include determining whether movements of the user in the PE represent intended user interaction with the virtual controllable object in the VE.

In Example 33, the subject matter of any one or more of Examples 23-32 optionally include determining user activity in the VE as it relates to interaction of the user with the virtual controllable object in the VE.

In Example 34, the subject matter of any one or more of Examples 23-33 optionally include determining when to display the vUI in the HMD based on a position of the user in the PE relative to the physical surface.

In Example 35, the subject matter of Example 34 optionally includes wherein determining when to display the vUI in the HMD is further based on hand actions of the user relative to the physical surface.

In Example 36, the subject matter of any one or more of Examples 23-35 optionally include determining selection and arrangement of virtual controls of the vUI based on an activity context of the VE.

In Example 37, the subject matter of Example 36 optionally includes wherein the activity context of the VE includes a type determination of the virtual controllable object.

Example 38 is at least one machine-readable medium containing instructions that, when executed on computing hardware, cause the computing hardware to carry out the method according to any one of Examples 23-37.

Example 39 is a system for controlling a head-mounted display (HMD) device to be worn by a user in a physical environment, the system comprising means for carrying out the method according to any one of Examples 23-37.

Example 40 is at least one machine-readable medium comprising instructions that, when executed on computing hardware, cause the computing hardware to control a head-mounted display (HMD) device to be worn by a user in a physical environment (PE), wherein in response to execution of the instructions the computing hardware is to: model a 3D virtual environment (VE), including a virtual controllable object subject to virtual control input; monitor to detect motion of the position, head, and hands of the user in the PE, and to detect a physical surface in the PE; and determine placement of a virtual user interface (vUI) in the VE relative to a virtual perspective of the user in the VE, to coincide with the physical surface in the PE relative to the position of the user in the PE, wherein the vUI includes an information display and at least one virtual touch control to produce the virtual control input in response to virtual manipulation of the virtual touch control.

In Example 41, the subject matter of Example 40 optionally includes wherein the virtual manipulation of the virtual touch control corresponds to physical interaction with the physical surface by the user.

In Example 42, the subject matter of Example 41 optionally includes wherein the virtual manipulation of the virtual touch control is detected as a result of physical interaction with the physical surface by the user.

In Example 43, the subject matter of any one or more of Examples 40-42 optionally include instructions to cause the computing hardware to detect actions of the user in the PE relating to user operation of the vUI in the VE.

In Example 44, the subject matter of any one or more of Examples 40-43 optionally include instructions to cause the computing hardware to recognize physical objects in the PE.

In Example 45, the subject matter of any one or more of Examples 40-44 optionally include instructions to cause the computing hardware to render perspective-view imagery of parts of the VE from a vantage point of the user, and provide perspective-view imagery output for display on the HMD device.

In Example 46, the subject matter of any one or more of Examples 40-45 optionally include instructions to cause the computing hardware to perform graphical rendering of a perspective view of the vUI for display on the HMD device.

In Example 47, the subject matter of Example 46 optionally includes instructions to cause the computing hardware to adjust the perspective-view graphical rendering of the vUI in response to motion of the user such that the vUI appears fixed in the VE.

In Example 48, the subject matter of any one or more of Examples 46-47 optionally include instructions to cause the computing hardware to at least partially occlude the perspective-view graphical rendering of the vUI in response to user hand positioning in the PE between the HMD and a location in the PE corresponding to a location of the vUI in the VE relative to the head of the user.

In Example 49, the subject matter of any one or more of Examples 40-48 optionally include instructions to cause the computing hardware to determine whether movements of the user in the PE represent intended user interaction with the virtual controllable object in the VE.

In Example 50, the subject matter of any one or more of Examples 40-49 optionally include instructions to cause the computing hardware to determine user activity in the VE as it relates to interaction of the user with the virtual controllable object in the VE.

In Example 51, the subject matter of any one or more of Examples 40-50 optionally include instructions to cause the computing hardware to determine when to display the vUI in the HMD based on a position of the user in the PE relative to the physical surface.

In Example 52, the subject matter of Example 51 optionally includes instructions to cause the computing hardware to further determine when to display the vUI in the HMD based on hand actions of the user relative to the physical surface.

In Example 53, the subject matter of any one or more of Examples 40-52 optionally include instructions to cause the computing hardware to determine selection and arrangement of virtual controls of the vUI based on an activity context of the VE.

In Example 54, the subject matter of Example 53 optionally includes wherein the activity context of the VE includes a type determination of the virtual controllable object.

Example 55 is a system for controlling a head-mounted display (HMD) device to be worn by a user in a physical environment (PE), the system comprising: means for modeling a 3D virtual environment (VE) to include a virtual controllable object subject to virtual control input; means for detecting motion of the position, head, and hands of the user in the PE, and detecting a physical surface in the PE; and means for determining placement of a virtual user interface (vUI) in the VE relative to a virtual perspective of the user in the VE, to coincide with the physical surface in the PE relative to the position of the user in the PE, the vUI including an information display and at least one virtual touch control to produce the virtual control input in response to virtual manipulation of the virtual touch control.

In Example 56, the subject matter of Example 55 optionally includes wherein the virtual manipulation of the virtual touch control corresponds to physical interaction with the physical surface by the user.

In Example 57, the subject matter of Example 56 optionally includes wherein the virtual manipulation of the virtual touch control is detected as a result of physical interaction with the physical surface by the user.

In Example 58, the subject matter of any one or more of Examples 55-57 optionally include means for detecting actions of the user in the PE relating to user operation of the vUI in the VE.

In Example 59, the subject matter of any one or more of Examples 55-58 optionally include means for varying an appearance of the vUI in the VE.

In Example 60, the subject matter of any one or more of Examples 55-59 optionally include means for rendering perspective-view imagery of parts of the VE from a vantage point of the user for display on the HMD device.

In Example 61, the subject matter of any one or more of Examples 55-60 optionally include means for rendering a perspective view of the vUI for display on the HMD device.

In Example 62, the subject matter of Example 61 optionally includes wherein the means for rendering of the perspective view of the vUI include means for adjusting the perspective-view rendering of the vUI in response to motion of the user such that the vUI appears fixed in the VE.

In Example 63, the subject matter of any one or more of Examples 61-62 optionally include wherein the means for rendering of the perspective view of the vUI include means for at least partially occluding the vUI in response to user hand positioning in the PE between the HMD and a location in the PE corresponding to a location of the vUI in the VE relative to the head of the user.

In Example 64, the subject matter of any one or more of Examples 55-63 optionally include means for determining whether movements of the user in the PE represent intended user interaction with the virtual controllable object in the VE.

In Example 65, the subject matter of any one or more of Examples 55-64 optionally include means for determining user activity in the VE as it relates to interaction of the user with the virtual controllable object in the VE.

In Example 66, the subject matter of any one or more of Examples 55-65 optionally include means for determining when to display the vUI in the HMD based on a position of the user in the PE relative to the physical surface.

In Example 67, the subject matter of Example 66 optionally includes wherein determining when to display the vUI in the HMD is further based on hand actions of the user relative to the physical surface.

In Example 68, the subject matter of any one or more of Examples 55-67 optionally include determining selection and arrangement of virtual controls of the vUI based on an activity context of the VE.

In Example 69, the subject matter of Example 68 optionally includes wherein the activity context of the VE includes a type determination of the virtual controllable object.

In Example 70, the subject matter of any one or more of Examples 55-69 optionally include wherein the system is incorporated in the HMD device.

In Example 71, the subject matter of any one or more of Examples 55-70 optionally include wherein the HMD device is a virtual-reality device.

In Example 72, the subject matter of any one or more of Examples 55-71 optionally include wherein the HMD device is an augmented-reality device.

In Example 73, the subject matter of any one or more of Examples 55-72 optionally include D camera to detect locations of physical surfaces in the PE relative to the HMD device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. Apparatus for controlling a head-mounted display (HMD) device to be worn by a user in a physical environment, the apparatus comprising:
a computing platform including processor, data storage, and input/output devices, the computing platform containing instructions that, when executed cause the computing platform to implement:
a virtual environment (VE) modeler to model a 3D VE, including a virtual controllable object subject to virtual control input;
a physical environment (PE) monitor to detect motion of the position, head, and hands of the user in the PE, and to detect a physical surface in the PE; and
a virtual user interface (vUI) engine to determine placement of a vUI in the VE relative to a virtual perspective of the user in the VE, to coincide with the physical surface in the PE relative to the position of the user in the PE, wherein the vUI includes an information display and at least one virtual touch control to produce the virtual control input in response to virtual manipulation of the virtual touch control.

2. The apparatus of claim 1, wherein the PE monitor includes a physical object detection engine to recognize physical objects in the PE.

3. The apparatus of claim 1, further comprising: a vUI renderer to perform graphical rendering of a perspective view of the vUI for display on the HMD device.

4. The apparatus of claim 3, wherein the vUI renderer is to adjust the perspective-view graphical rendering of the vUI in response to motion of the user such that the vUI appears fixed in the VE.

5. The apparatus of claim 3, wherein the vUI renderer is to at least partially occlude the perspective-view graphical rendering of the vUI in response to user hand positioning in the PE between the HMD and a location in the PE corresponding to a location of the vUI in the VE relative to the head of the user.

6. The apparatus of claim 1, wherein the vUI engine includes a PE context assessor to determine whether movements of the user in the PE represent intended user interaction with the virtual controllable object in the VE.

7. The apparatus of claim 1, wherein the vUI engine includes a VE context assessor to determine user activity in the VE as it relates to interaction of the user with the virtual controllable object in the VE.

8. The apparatus of claim 1, wherein the vUI engine includes a touchscreen display decision engine to determine when to display the vUI in the HMD based on a position of the user in the PE relative to the physical surface.

9. The apparatus of claim 8, wherein the touchscreen display decision engine is to further determine when to display the vUI in the HMD based on hand actions of the user relative to the physical surface.

10. The apparatus of claim 1, wherein the vUI engine includes a controls configurator to determine selection and arrangement of virtual controls of the vUI based on an activity context of the VE.

11. The apparatus of claim 10, wherein the activity context of the VE includes a type determination of the virtual controllable object.

12. The apparatus of claim 1, further comprising: a computing platform including a processor, a data store, and input/output facilities, the computing platform to implement the VE modeler, the PE monitor and the vUI engine.

13. A machine-implemented method for controlling a head-mounted display (HMD) device to be worn by a user in a physical environment (PE), the method comprising:
computationally modeling a 3D virtual environment (VE) to include a virtual controllable object subject to virtual control input; and
determining placement of a virtual user interface (vUI) in the VE relative to a virtual perspective of the user in the VE, to coincide with the physical surface in the PE relative to the position of the user in the PE, the vUI including an information display and at least one virtual touch control to produce the virtual control input in response to virtual manipulation of the virtual touch control, wherein the determining placement is based on detection of motion of the position, head, and hands of the user in the PE, and on detection of a physical surface in the PE.

14. The method of claim 13, further comprising:
rendering a perspective view of the vUI for display on the HMD device, including at least partially occluding the vUI in response to user hand positioning in the PE between the HMD and a location in the PE corresponding to a location of the vUI in the VE relative to the head of the user.

15. The method of claim 13, further comprising determining whether movements of the user in the PE represent intended user interaction with the virtual controllable object in the VE.

16. The method of claim 13, further comprising determining user activity in the VE as it relates to interaction of the user with the virtual controllable object in the VE.

17. At least one machine-readable medium comprising instructions that, when executed on computing hardware, cause the computing hardware to control a head-mounted display (HMD) device to be worn by a user in a physical environment (PE), wherein in response to execution of the instructions the computing hardware is to:
model a 3D virtual environment (VE), including a virtual controllable object subject to virtual control input;
monitor to detect motion of the position, head, and hands of the user in the PE, and to detect a physical surface in the PE; and
determine placement of a virtual user interface (vUI) in the VE relative to a virtual perspective of the user in the VE, to coincide with the physical surface in the PE relative to the position of the user in the PE, wherein the vUI includes an information display and at least one virtual touch control to produce the virtual control input in response to virtual manipulation of the virtual touch control.

18. The at least one machine-readable medium of claim 17, further comprising:
instructions to cause the computing hardware to recognize physical objects in the PE.

19. The at least one machine-readable medium of claim 17, further comprising:
instructions to cause the computing hardware to perform graphical rendering of a perspective view of the vUI for display on the HMD device and to at least partially occlude the perspective-view graphical rendering of the vUI in response to user hand positioning in the PE between the HMD and a location in the PE corresponding to a location of the vUI in the VE relative to the head of the user.

20. The at least one machine-readable medium of claim 17, further comprising:
instructions to cause the computing hardware to determine whether movements of the user in the PE represent intended user interaction with the virtual controllable object in the VE.

21. The at least one machine-readable medium of claim 17, further comprising:
instructions to cause the computing hardware to determine user activity in the VE as it relates to interaction of the user with the virtual controllable object in the VE.

22. The at least one machine-readable medium of claim 17, further comprising:
instructions to cause the computing hardware to determine when to display the vUI in the HMD based on a position of the user in the PE relative to the physical surface.

23. The at least one machine-readable medium of claim 22, further comprising:
instructions to cause the computing hardware to further determine when to display the vUI in the HMD based on hand actions of the user relative to the physical surface.

24. The at least one machine-readable medium of claim 17, further comprising:
instructions to cause the computing hardware to determine selection and arrangement of virtual controls of the vUI based on an activity context of the VE.

25. The at least one machine-readable medium of claim 24, wherein the activity context of the VE includes a type determination of the virtual controllable object.
